(19) United States
(12) Patent Application Publication
(10) Pub. No.: US 2013/0233211 A1
(43) Pub. Date: Sep. 12, 2013

(54) Method for Using Hybrid Concrete Safes and Attaching Banking Equipment by Anchoring

(71) Applicant: Nelson Tavares de Pinho, Sao Paulo (BR)

(72) Inventor: Nelson Tavares de Pinho, Sao Paulo (BR)

(73) Assignee: TECNOLOGIA BANCARIA S.A., Alphaville - Barueri - SP (BR)

(21) Appl. No.: 13/823,185

(22) PCT Filed: Sep. 6, 2011
(86) PCT No.: PCT/BR2011/000318

§ 371 Date: May 29, 2013

(30) Foreign Application Priority Data
Sep. 14, 2010 (BR) PI 1003773-0

(51) Int. Cl. E05G 1/02

(52) U.S. Cl. CPC E05G 1/02
USPC 109/51

(57) ABSTRACT

Method for using hybrid concrete safes and attaching banking equipment by anchoring, and more specifically a method for using hybrid concrete safes and attaching banking equipment such as ATMs and cash dispensers, that involves using a hybrid concrete safe (1) and (2) to assemble cash dispensers using standard internal components from manufacturers, in which the components such as the internal module, monitor, printer, card reader and upper housing are supplied by different manufacturers, allowing independent assemblies (28) and (34).

### TECHNICAL FIELD

This specification relates a patent of invention relating to a method for using hybrid concrete safes and attaching banking equipment, such as ATMs and cash dispensers.

### STATE OF THE ART BACKGROUND

As it is generally known, for several years banking institutions have offered its clients a number of facilities, among them the ATMs, which are machines usually located outside the bank where one can make banking operations, including withdrawing cash.

The banking institutions further offer equipment known as cash dispenser, mounted in a public space, and which allows withdrawing cash and making other operations.

Generally, the construction of both ATM and cash dispenser shows a construction that may offer safe to avoid attacks or damage.

However, lately the violent attacks by thieves against such equipment (ATMs and cash dispensers) have shown that the means used for their security need and must be reviewed.

### BRIEF DESCRIPTION OF THE INVENTION

In view of such drawback, this patent of invention refers to a method for using and attaching hybrid concrete safes, and security means applicable to both ATMs and cash dispensers.

The method disclosed herein primarily shows the main characteristics or approaches to solve the above-mentioned drawback, as follows: a) equipment safe having concrete wall finished inside and outside with a thin sheet on the sides, bottom, base, upper face and door; b) improvement of the door locking means of the equipment; and c) system for attaching the equipment with special attaching kit and anchoring kit.

### BRIEF DESCRIPTION OF THE DRAWINGS

The present invention may be better understood in all its particularities by means of the detailed description of the invention based on the drawings listed herein below, in which:

FIG. 1 shows the three views of the concrete safe for the cash dispenser where the safe walls and door feature concrete shielding;

FIG. 2 shows a general and isometric view of the concrete safe for cash dispenser;

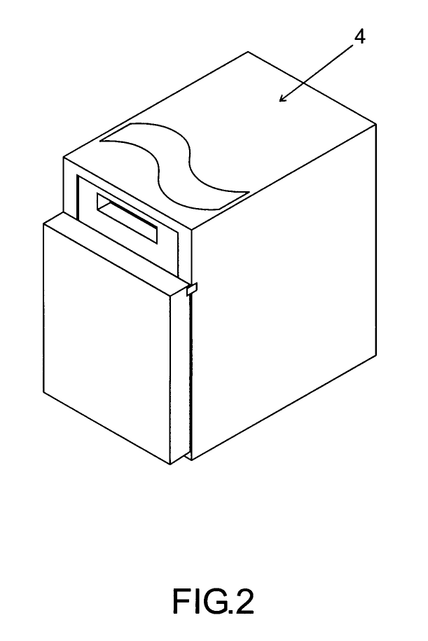

FIG. 3 shows an internal view of the side wall of the concrete safe for cash dispenser where the materials forming the wall are specified;

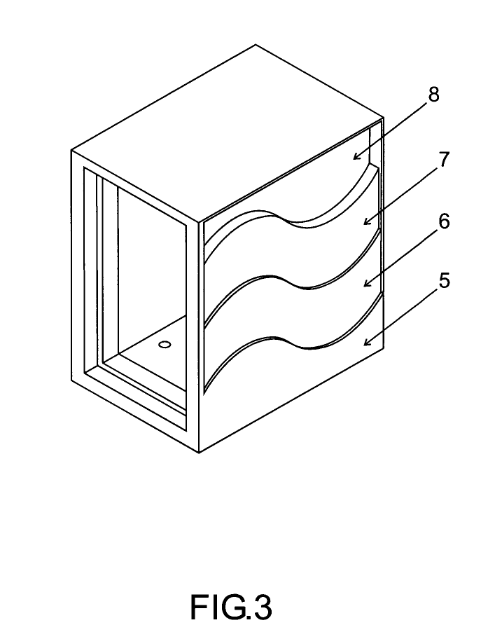

FIG. 4 shows an internal view of the upper face of the concrete safe for cash dispenser where the materials forming the face are specified;

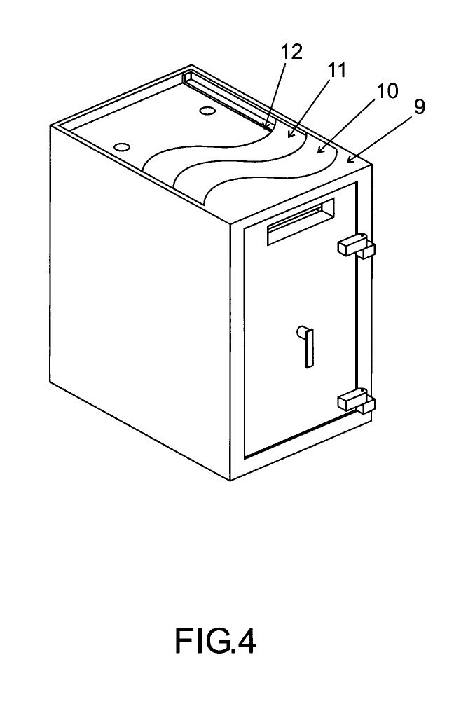

FIG. 5 shows an internal view of the door of the concrete safe for cash dispenser where the materials forming the door are specified;

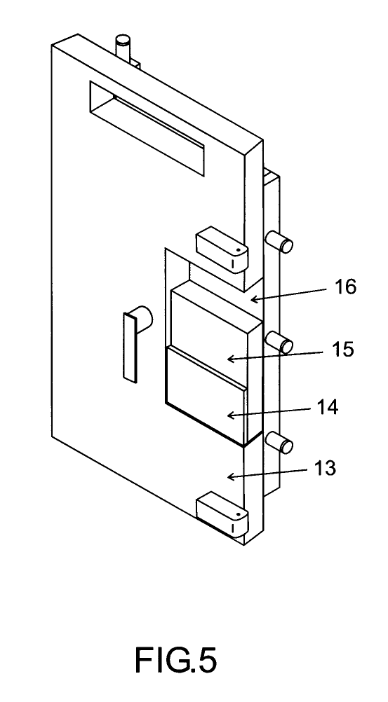

FIG. 6 shows the three views of the door mechanism of the concrete safe for cash dispenser;

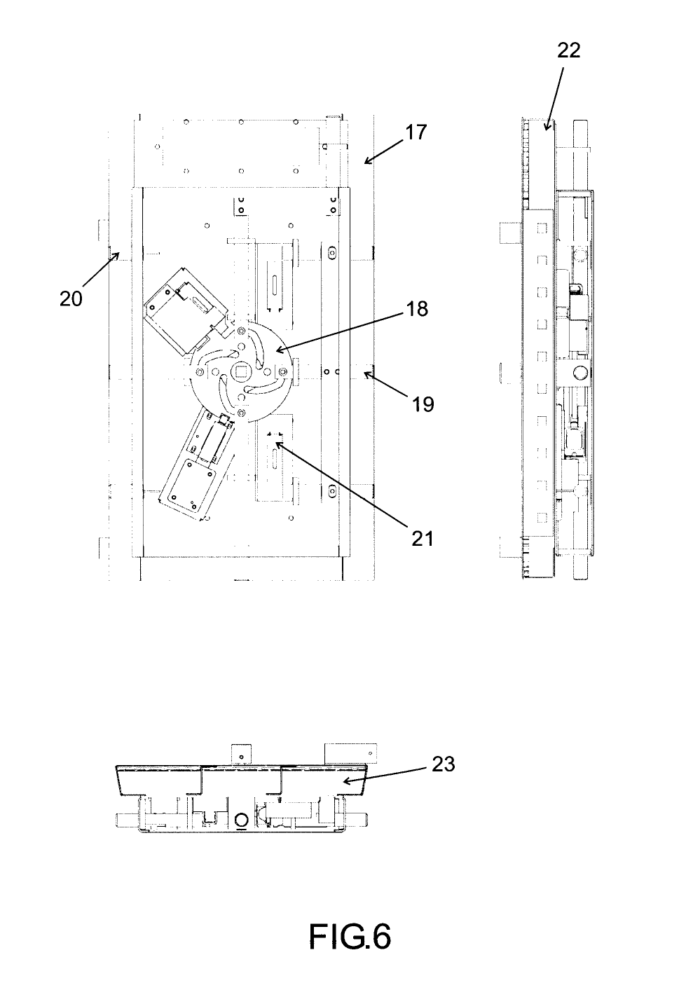

FIG. 7 shows a detail of a pin and ball plate used to reinforce the region where the locks of the safe door are located;

FIG. 8 shows a general and isometric view of a piece of equipment such as a cash dispenser mounted on a concrete safe;

FIG. 9 shows an exploded view of FIG. 8 indicating the standard components of the equipment mounted on the concrete safe;

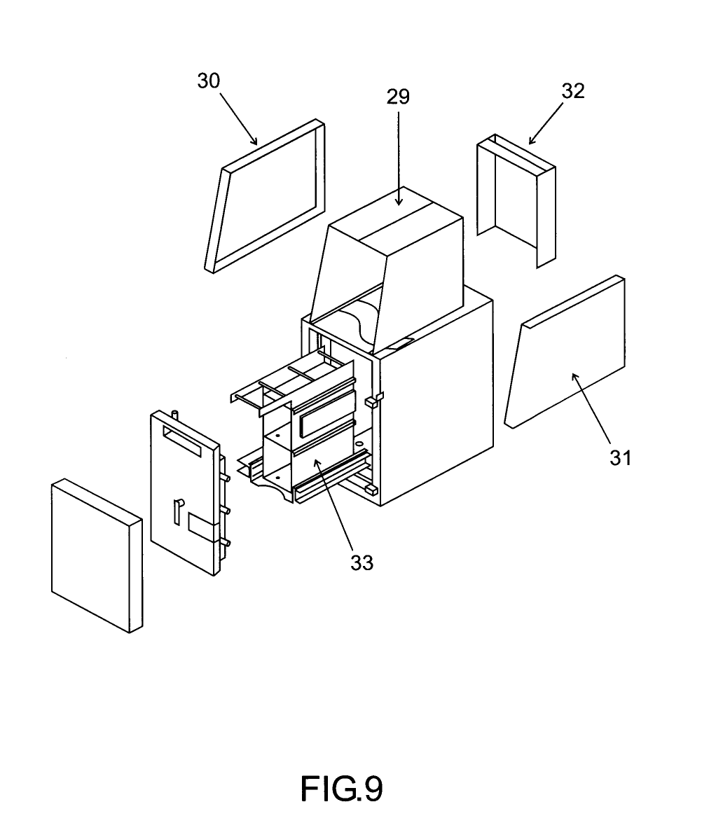

FIG. 10 shows a general and isometric view of a piece of equipment such as a cash dispenser mounted on a concrete safe;

FIG. 11 shows an exploded view of FIG. 10 indicating the standard components of the equipment mounted on the concrete safe;

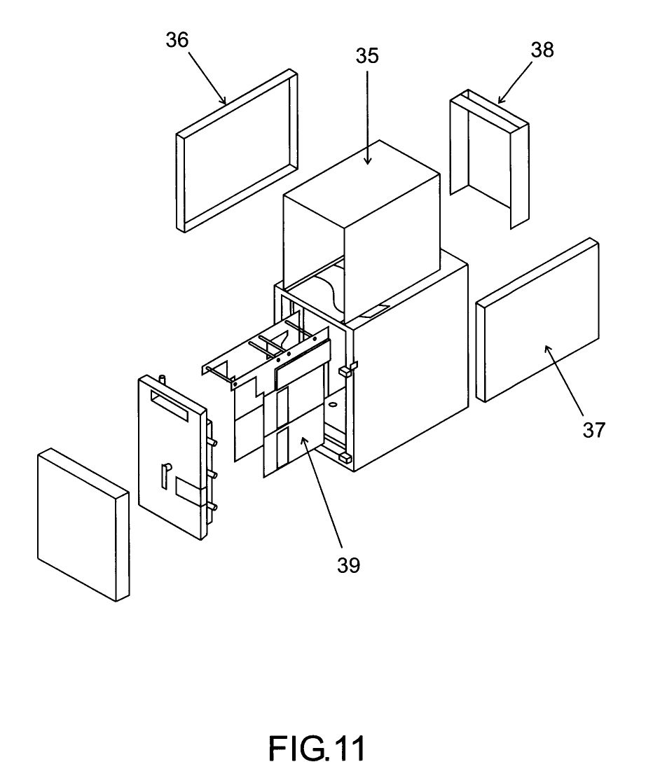

FIG. 12 shows an exploded view of the special anchoring kit for the concrete safe; and

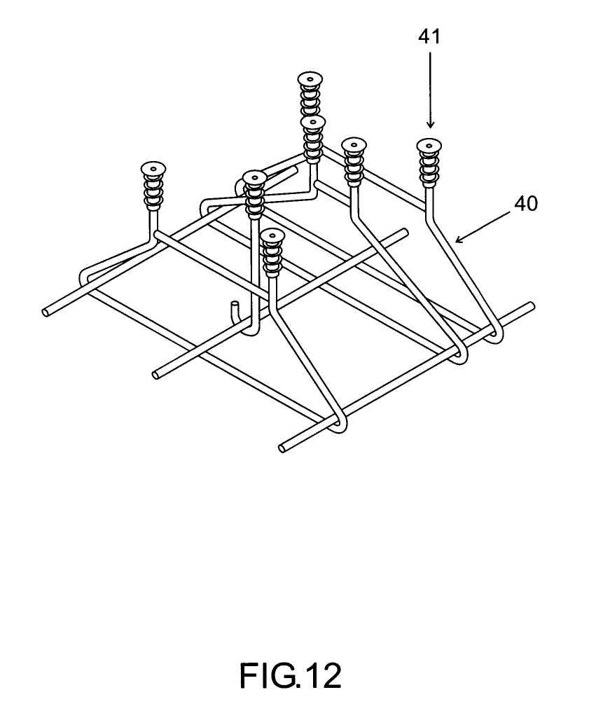

FIG. 13 shows an exploded view of the special attaching kit for the concrete safe.

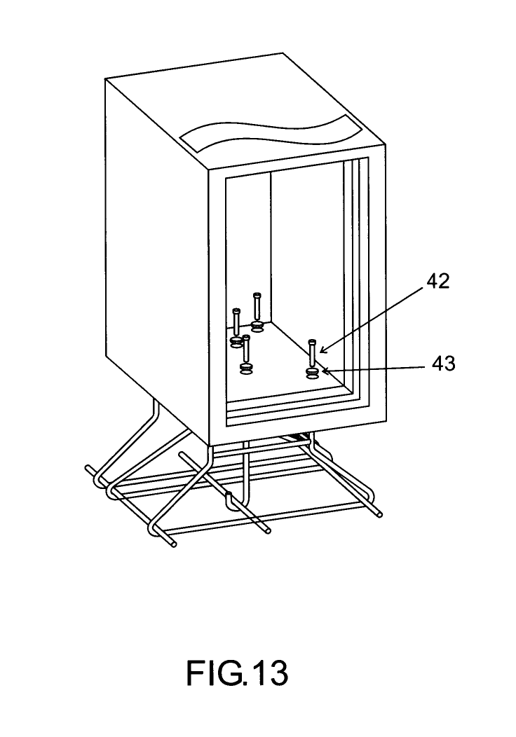

### DETAILED DESCRIPTION OF THE INVENTION

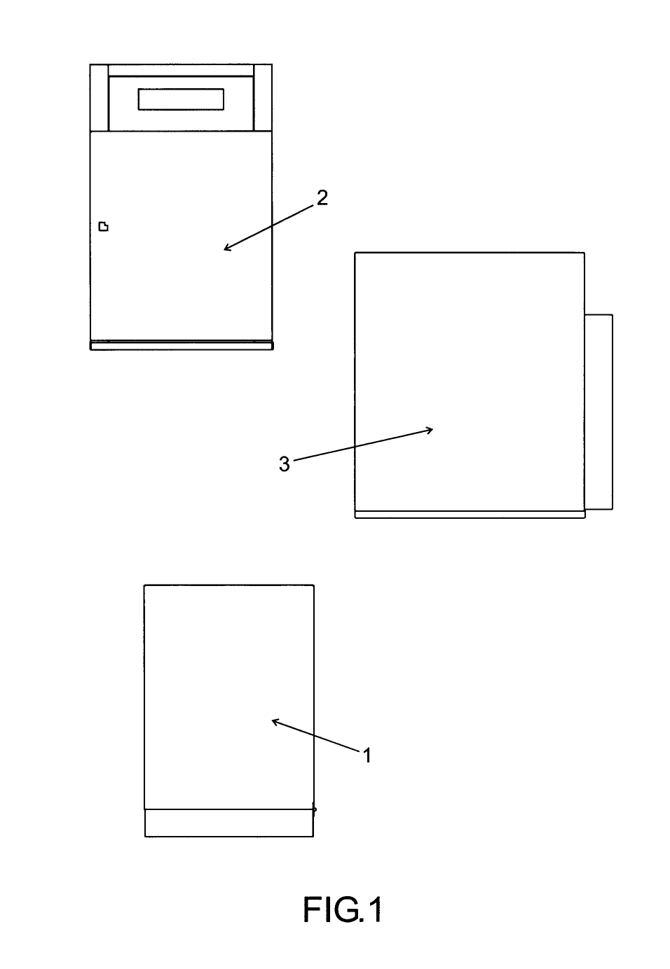

According to what is shown by the above-mentioned drawings, the method of this invention comprises a number of reinforcement devices and elements whose purpose is to impede access to the inside of the equipment (ATMs or Cash Dispenser). One of the main details of the method proposed comprises the manufacture of a concrete safe with different dimensions in order to allow mounting the equipment, such as a Cash Dispenser, with internal components, regardless of the manufacturer, as shown in FIG. 1.

For such purpose a plan view 1, elevation view 2, side view 3 and isometric view 4 of the concrete safe are shown.

In general lines, the wall of the concrete safe features layers of materials intended to provide resistance to burglary.

The side walls, bottom and upper face of the concrete safe have the same thickness and external components.

Regarding the layers forming the safe wall, we have a steel plate 5, chemical protection 6, special concrete 7 and steel plate 8.

The chemical protection that forms layer 6 is essentially comprised by a flammable compound containing bitumen, tar and sulfur in properly specified amounts and layer thickness. This compound protects the unit against attacks that use a torch.

On the other hand, layer 7 forming the mechanical protection is made of reinforced concrete containing cement, Coridon (mineral) and Dramix (steel fiber) in specified amounts. Such concrete offers high resistance to abrasion and impact, thus providing protection against attacks with drillers and punchers.

The upper face of the concrete safe has the same thickness and components as the sides and bottom.

Regarding the layers shown, we have an external steel plate 9, chemical protection 10, concrete 11 and steel plates 12 with different thickness.

The door of the concrete safe has the same thickness as the side and features similar internal components. Regarding the layers forming the safe door, we have a steel plate 13, chemical protection 14, special concrete 15 and steel plate 16.

Another approach of this method comprises the improvement of the locking mechanisms of the safe door in order to provide more resistance to burglary, and thus, some items are included or changed to achieve the level of safety desired.

The front view of mechanism 17 shows one of its main items, i.e. the cam 18. As the cam is moved the safe door can be either locked or unlocked by using latches 19.

The fixed latch 20 locks the safe door when it is closed. The invention further discloses auxiliary locking systems 21 interconnected by means of wire ropes, which if broken, lock strategic points of the mechanism.

The auxiliary side 22 and plan 23 views complement the door mechanism of the concrete safe.

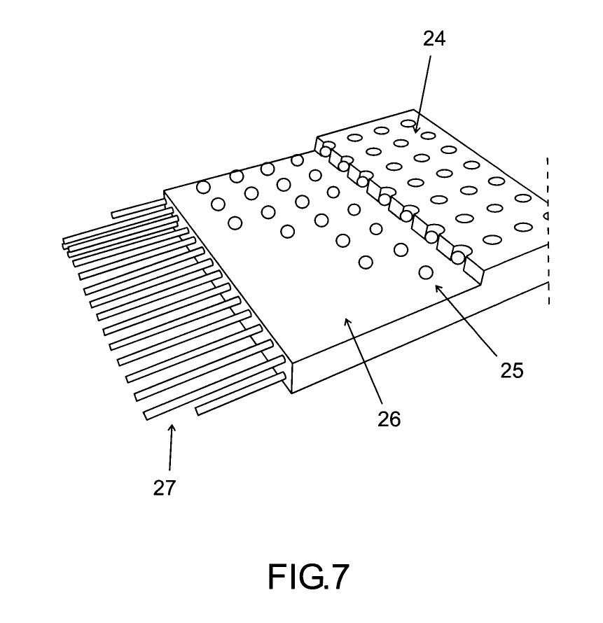

FIG. 7 shows a detail of the reinforcement plate positioned in the door lock region. The material consists of a drilled steel plate 24 where special steel balls 25 are housed. The steel plate 26 features cylindrical holes where special steel pins are housed.

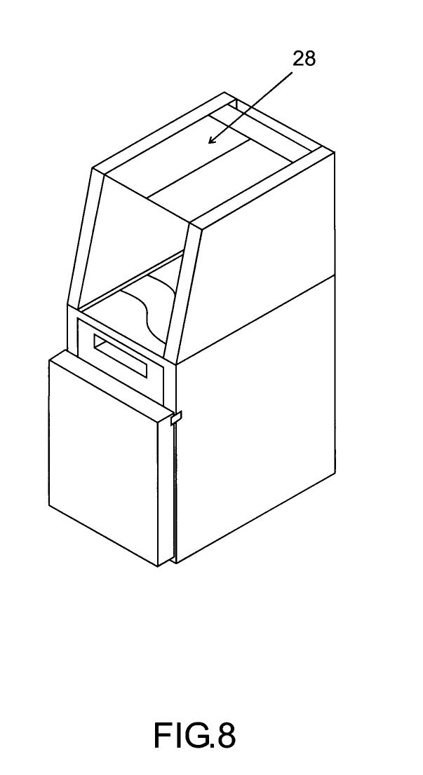

The method further provides mounting the equipment such as a cash dispenser by using standard manufacturer concrete safe and internal components. FIG. 8 shows a cash dispenser using the concrete safe.

The upper enclosure of the equipment 29 houses some accessories such as monitor, printer and card reader. Items 30 and 31 refer to the complementation of the concrete safe wall in the upper enclosure of the equipment. The rear cover 32 on the bottom is in line with the rear external face of the concrete safe and lateral complementation.

The internal module of the safe 33 shelters the cash and rejection cassettes and is supplied by the equipment manufacturer.

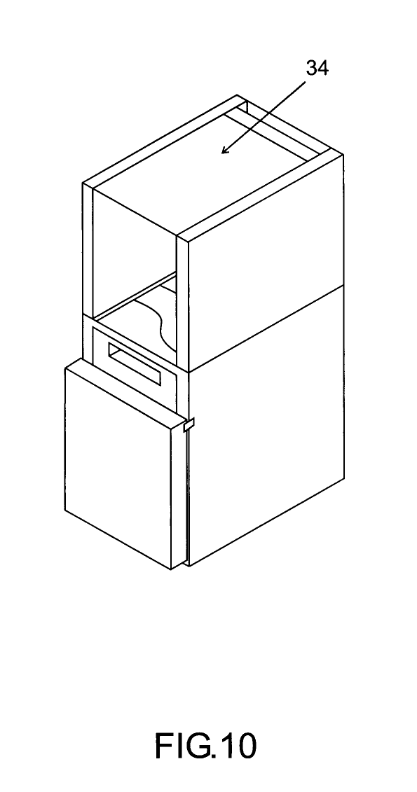

FIG. 10 shows another assembly of the cash dispenser using the same concrete safe.

The invention comprises the equipment upper enclosure 35, side complementation pieces 36 and 37 and rear complementation 38. The internal module of the safe 39 is provided by another equipment manufacturer.

The system for anchoring the concrete safe consists of a set of metallic trapezoidal, umbrella-handle and smooth bar-like hardware 40. The trapezoidal and umbrella-handle-like hardware feature grooved metallic bushing 41 welded to the entire contour.

For the installation of the anchorage a hole is drilled in the floor of the installation site. Hardware pieces are screwed to a template positioned on the floor and concrete is poured through the template holes.

After the concrete cure time, the safe is positioned with the internal drilling centralized with the holes of the anchorage bushing. For attaching the safe to the anchorage bushing special alloy steel anchoring bolts 42 and steel washers of different thickness 43 are used.

1. A method for using hybrid concrete safes and attaching banking equipment such as ATMs and cash dispensers, wherein the providing of the use of a hybrid concrete safe and to mount cash dispensers using standard manufacturer internal components, wherein components such as internal module, monitor, printer, card reader, and upper enclosure are supplied by different manufacturers, allowing independent assemblies and.

2. The method of claim 1, wherein the providing of the use of a concrete safe for equipment such as cash dispenser using internal components in its composition such as reinforced concrete containing cement, mineral, such as Coridon and steel fiber such as Dramix, in addition to chemical protection consisting of bitumen, tar and sulfur, thus providing the entire safe with a greater mechanical protection.

3. The method of claim 1, wherein the providing of the improvement of the locking mechanisms of the equipment door by means of the use of latches, a movable part made of steel responsible for closing and locking the safe when positioned inside its respective housing; the horizontal movement of the latches is obtained by driving (turning) the came, which is driven by the door handle; the came is in turn a part that prevents moving the latches in any condition of application of horizontal effort.

4. The method of claim 1, wherein the providing of the use of pin and ball plates, and made of reinforced steel with specific dimensions and positioned in the inner side of the door in the region of the lock, thus providing a greater mechanical protection in this region.

5. The method of claim 1, wherein by providing of the installation of equipment such as a cash dispenser using an anchoring system by means of a set of trapezoidal, umbrella-handle and smooth bar-like hardware called anchorage, and the tips of the trapezoidal, umbrella-handle and smooth bar-like hardware featuring welded grooved steel bushing to allow attaching the equipment, wherein the equipment is fastened to the bushing by a set of bolts and washer, and the bolt material is a special thermally treated steel alloy, which adds resistance necessary for attaching the equipment.
